(19) United States
(12) Patent Application Publication
(10) Pub. No.: US 2026/0311242 A1
(43) Pub. Date: Oct. 8, 2026

(54) REAL ESTATE TRANSACTION SYSTEMS AND METHODS

(71) Applicant: ZUMEDIA INC., New York, NY (US)

(72) Inventors: Phyllis Jager, New York, NY (US); Barry Terach, Goshen, NY (US); Mark Cuban, Dallas, TX (US)

(21) Appl. No.: 19/172,532

(22) Filed: Apr. 7, 2025

(51) Int. Cl. G06Q 30/0601; G06Q 50/16

(52) U.S. Cl. CPC G06Q 30/0641; G06Q 50/16

(57) ABSTRACT

A system enables a platform for multiple stakeholders to operate real estate transactions in a streamlined manner with reduced needs for time, money, transaction friction, and computer resources. The system allows all stakeholders—users—to cooperatively participate in real estate transactions according to their relative roles, e.g., buyer, seller, real estate agent, attorney, lender.

### FIELD OF THE DISCLOSURE

This application relates generally to new methods of coordinating real estate transactions, and specifically to systems and methods providing for efficient real estate transactions.

### BACKGROUND

A system enables a platform for multiple stakeholders to operate real estate transactions in a streamlined manner with reduced needs for time, money, transaction friction, and computer resources. The system allows all stakeholders—users—to cooperatively participate in real estate transactions according to their relative roles, e.g., buyer, seller, real estate agent, attorney, lender. By hosting all documents, providing communication means for all users, and enabling financial exchanges, the complication, frictions, and delays related to these transactions can be reduced. The system can be implemented using any of a number of different communication platforms, such as the Internet.

### SUMMARY

In one embodiment, the innovation includes an electronic device comprising a processor and memory. The memory stores instructions for execution by the processor. The processor receives user input comprising a user profile. Each user profile can be indicative of a user request, e.g. if the user indicates they want to sell a house, an appropriate user profile template is automatically generated for that user as a house seller, which can be different from a house buyer template. This technology provides efficient means for obtaining specific context information associated with the user profile of the electronic device. The user profile is processed to obtain a representation of user intent, wherein the representation of user intent associates the user profile with a specific task flow operationalizing a requested task. The task flow is operable to invoke one or more services of a plurality of services, each service of the plurality of services supporting one or more functions according to a respective set of one or more service parameters enabling user input to execute the task flow and invoke the one or more services.

This technology provides a computing system comprising a processor that, based on stored instructions, determines a user's intent upon the user accessing different modules stored on the processor, provides the user with a specific task flow associated with the user's intent, wherein the task flow provides one or more services of a plurality of services, each service of the plurality of services supporting one or more functions according to a respective set of one or more service parameters.

### BRIEF DESCRIPTION OF THE DRAWINGS

FIG. 1 is a schematic example of the real estate transaction system as disclosed herein.

FIG. 2 is a schematic of an exemplary listing system of the real estate transaction system disclosed.

FIG. 3 is a schematic of an exemplary notification system of the real estate transaction system disclosed.

FIG. 4 is a schematic of an exemplary roundtable system of the real estate transaction system disclosed.

FIGS. 5-9 are schematics of exemplary dashboard systems of the real estate transaction system disclosed.

FIGS. 10-14 are schematics of exemplary advertising systems of the real estate transaction system disclosed.

FIGS. 15-19 are schematics of exemplary search systems of the real estate transaction system disclosed.

FIG. 20 is a schematic of an exemplary syndication system of the real estate transaction system disclosed.

FIG. 21 is an interaction diagram of an exemplary real estate transaction system.

### DETAILED DESCRIPTION

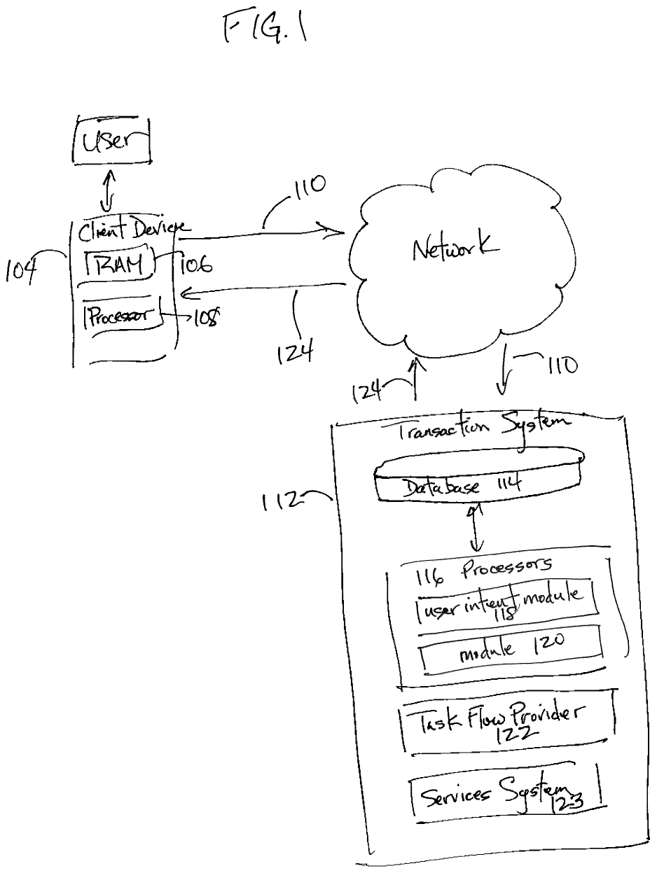

FIG. 1 illustrates an example of a real estate transaction system 112 for providing elements of real estate transactions to various stakeholders in those transactions. property listing process for the system and methods described. The transaction system 112 is an example of an information processing system in which the systems, components, and techniques described below can be implemented.

A user 102 can interact with the transaction system 112 through a client device 104. In some implementations, the client device 104 can communicate with the transaction system 112 over a network. For example, the client device 104 can be a computer or smart phone coupled to the search system 112 through one or more wired or wireless networks, e.g., mobile phone networks, local area networks (LANs) or wide area network (WAN), e.g., the Internet. In some implementations, the client device 104 can communicate directly with the transaction system 112. The transaction system 112 and the client device 104 can be implemented on one or more machines, e.g. computer. A user can install a desktop transaction system application on the client device 104. The transaction system 112 and the client device 104 can be implemented on a smart phone, i.e. a user can install an application (app) based transaction system on the client device 104. In some implementations, the transaction system 112 can be implemented as, for example, computer programs running on one or more computers in one or more locations that are coupled to each other through a network. The client device 104 can generally include a random access memory (RAM) 106, a processor 108, and one or more user interface devices, e.g., a display or speaker for output, and a keyboard, mouse, microphone, or touch sensitive display for input.

The transaction system 112 can comprise a database 114 and processors 116 with different modules 118, 120. The processors can include or access a user intent module 118.

A user 102 can use the client device 104 to access a real estate transaction at numerous access points described below. The user can use the one or more user interface devices of the client device 104 to access the transaction system 112. However, the first time a user is to access the system, the user 102 creates a profile 110. A profile 110 is utilized to describe the user based on predetermined, e.g., name, location, purpose, i.e. buyer, seller, etc., types of services, costs of services. The system can elicit input from a user 102 to build the profile by presenting questions to be answered by the user 102 and interpreting the answers.

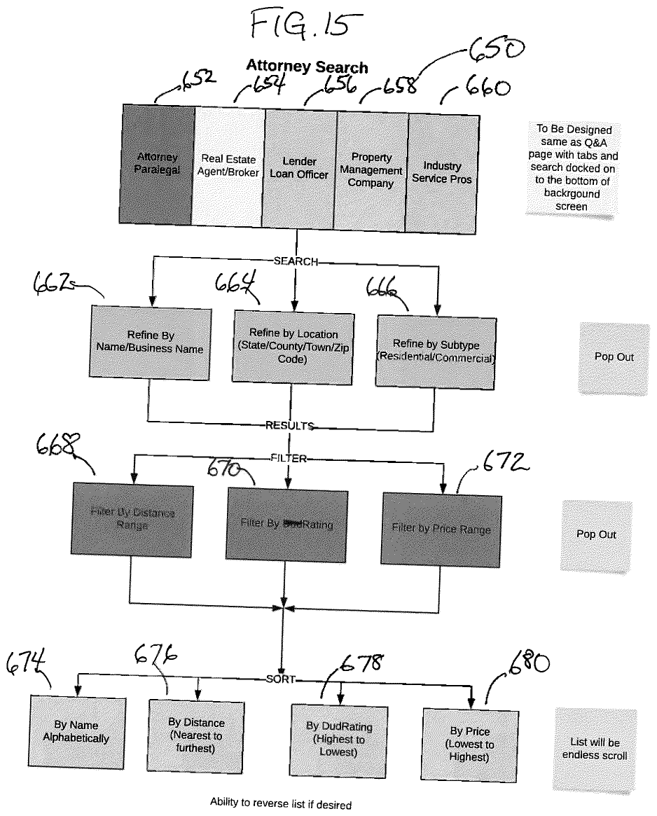

Based on the users 102 profile, a transaction system can determine the user's 102 intent upon accessing different modules of the system, e.g., user wants to sell property. The user intent can then be associated by the transaction system 112 with a specific task flow provided by the Task Flow Provider 122 and operationalizing one or more desired tasks, and wherein the task flow is operable to invoke one or more services of a plurality of services provided by the Service System 123, each service of the plurality of services supporting one or more functions according to a respective set of one or more service parameters, e.g., user 102 needs an attorney to represent user 102 and an attorney search workflow (e.g., as shown in FIG. 15) is presented to the user 102.

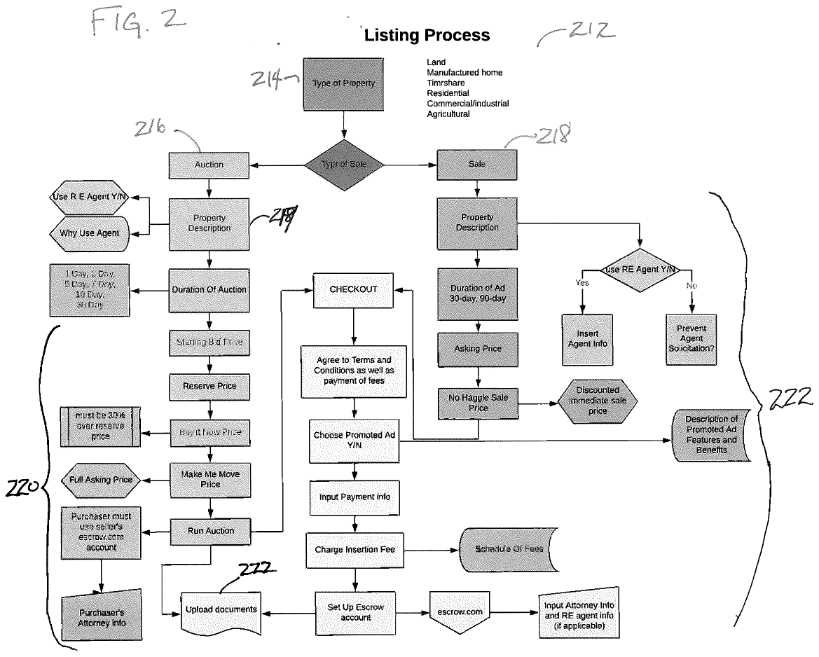

One access point for a user 102 can be at a listing process module. FIG. 2 illustrates an exemplary listing process module 212. A user 102 can list a type of real estate 214, e.g. land, timeshare, residential, commercial, industrial, agriculture. The user 102 can indicate the type of transaction 215, e.g., auction 216 or sale 218. For an auction 216, a property description 218 can be provided. The listing process module 212, can provide options and information 220 regarding the auction for the user 102 to utilize.

The user 102 can indicate a sale type transaction 218. In a sale transaction 218, the user can designate, choose or complete various options e.g. as shown in FIG. 2, 222.

The listing price module 212 provides for the user 102 to upload various documents 222 for the real estate transactions. The process of agreeing to the various terms, e.g., financial, timing, of a real estate transaction are automated by listing process module 212. The financial exchanges and document exchanges, e.g., escrow accounts, fees, prices, can be automated by the listing price module 212.

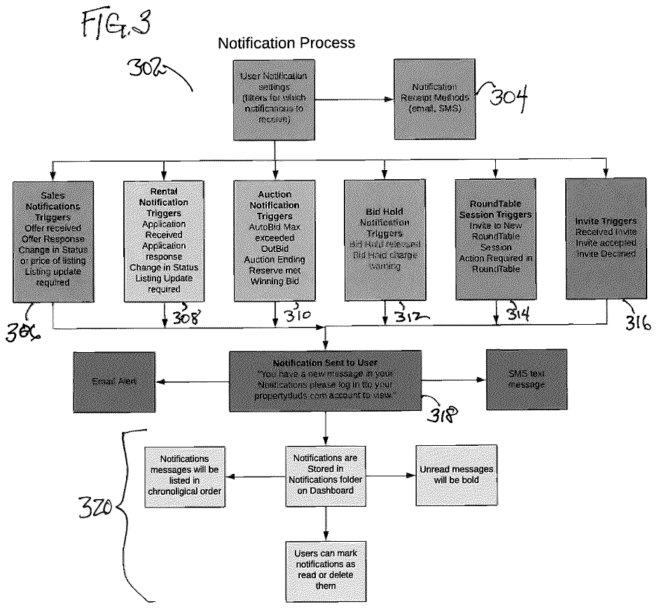

FIG. 3 illustrates an exemplary notification process 302 made available by the real estate transaction system 112 for a user 102. A user can be notified of various events that happen during the course of a real estate transaction. The use 102 can be provided with settings related to these notifications. The settings can include how notifications are sent, e.g. email, SMS. Types of notifications include sales notifications 306, e.g. offer received, offer response, change in status or price of listing, listing update required. Rental notifications 308 can include, e.g., application received, application response, change in status, listing update required. Auction notifications 310 can include, e.g., autobid maximum exceeded, outbids, auction endings, winning bids. Bid hold notifications 312 can include, e.g., bid hold released, bid hold change warnings. Roundtable session notifications 314 can include, e.g., invitations to a roundtable, action required for a roundtable. Invitation notifications 316 can include, e.g., receipt of invitation, invitation accepted, invitation declined. A user can receive a notification that a new notification has been received 318 and notifications can be stored and organized in various ways, e.g., 320.

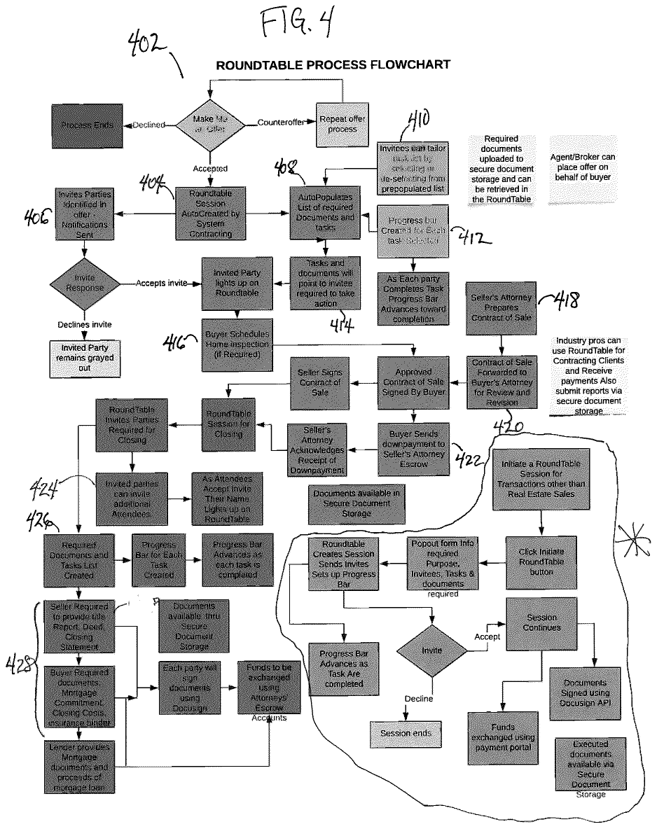

FIG. 4 illustrates an exemplary roundtable process 402 made available by the real estate transaction system 112 for a user 102. A roundtable of multiple participants in a real estate transaction can be automatically created 404 after an offer is accepted. Based on the type of transaction, the user profiles of the party making the offer and the party accepting the offer, and other characteristics tracked by the real estate transaction system 112, the roundtable process can automatically and dynamically build the infrastructure to negotiate and close the deal. The roundtable process 402 can automatically invite one or more of each user role necessary or desired to close the deal, e.g. attorneys, lenders. An automatically invited attorney user can be matched to the deal based on, e.g., prior deals with the same buyer or seller, prior deals in similar geographic location, expertise in small residential sales, availability, and other characteristics or any combination of the characteristics. These characteristics are determined by the real estate transaction system based on the profiles and continuous monitoring of each users activity. This allows the real estate transaction system 112 to dynamically create a roundtable process with users capable of closing the deal that has been entered.

Parties to the roundtable can be invited manually or automatically 406. The system can automatically populate a list of required or desired documents and tasks 408. A user can tailor this list according to each transaction 410. Documents can be automatically or manually be uploaded to a secure part of the system for use by the roundtable participants. A progress bar can be used for each task created by the system 412. Each task and document can automatically or manually indicate the roundtable participant that is required to take action in relation to the task/document 414. A buyer user on the roundtable can schedule a home inspection 416 with the system. A seller user or seller attorney user can prepare and upload a sales contract to the system 418, which can be directed to other members of the roundtable who have a need to view or work on the sales contract 420. Alternatively the real estate transaction system 112 can automatically load a system template sales contract, or an individual attorney user template to the roundtable. The roundtable process 402 can provide for the negotiation and execution of all documents used in a real estate transaction. The real estate transaction system 112 provides for the exchange of value 422, e.g., cash.

The roundtable process provides all invited party users an environment where they can collaborate in the negotiation and closing of a real estate transaction. Those invited can be allowed the ability to invite additional attendees to the roundtable 424. The real estate transaction system 112 can provide a roundtable process that creates document and task lists required for the roundtable attendees 426. Title reports, deeds, closing statements, mortgages commitments, closing costs, insurance binders, and other documents needed for the transaction can be upload, edited, and stored on the real estate transaction system 112 and made accessible to roundtable attendees 428.

The user buyer and user seller can be presented with alternative participants to the roundtable process 402. The user buyer and user seller can choose roundtable users from the alternative participants together or separately.

The real estate transaction system can comprise a computing device, comprising one or more processors, one or memories, and one or more programs, wherein the one or more programs are stored in the memory and configured to be executed by the one or more processors. The one or more programs can include instructions for receiving, within a communication session between a user and a system program, a user request for the system program to receive user input comprising a user profile, and obtaining context information associated with the user profile comprising role, expertise, abilities, users input, users past use, or other users feedback. In response to receiving the user request for the system program to receive user input comprising a user profile, the real estate transaction system can determine one or more user values based on each of the context information, use the user values based on the context information to create a roundtable of other users with compatible user values by: identifying one or more process needed done by at least one first user; determining other users that have compatible user values related to the first user including the ability to contribute to the process needing to be done; matching one or more of the best valued other users with the first user by choosing the closest values for each of the users; transmitting the other users to the first user; and receiving a response from the first user indicating whether the matching was successful.

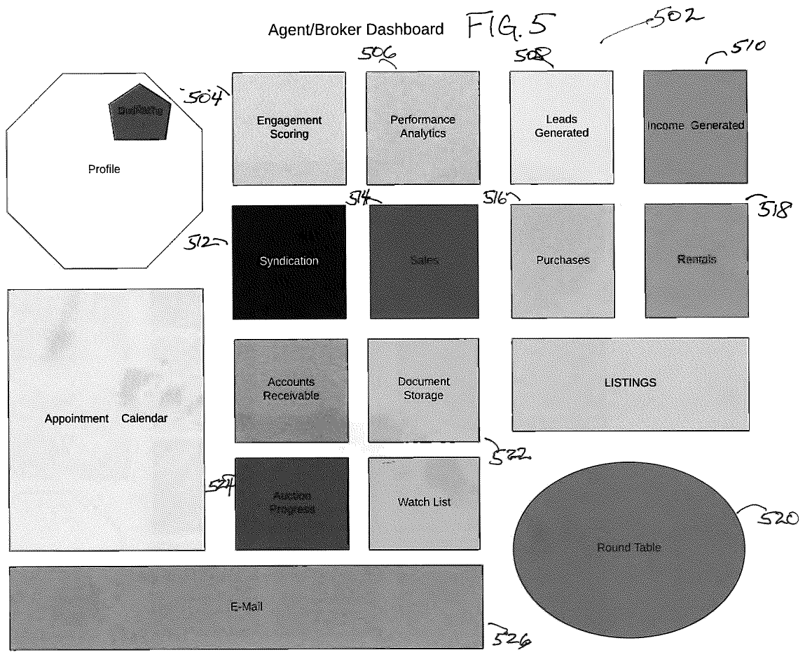

The real estate transaction system 112 can provide various dashboards for different users. FIG. 5 illustrates an exemplary real estate agent or broker dashboard schematic 502. The dashboard can provide these agent/broker users 102 an engagement score 504, performance analytics 506, leads lists 508, and income generated 510. The dashboard 502 can also provide syndication information 512, sales information 514, purchase information 516, and rental information 518, related to the agent/broker user 102. The dashboard 502 can also provide an agent broker user 102 with information and access to the roundtables of which they are attendees 520, the documents of which they have access 522, auction progress 524, and communication means with other users 526.

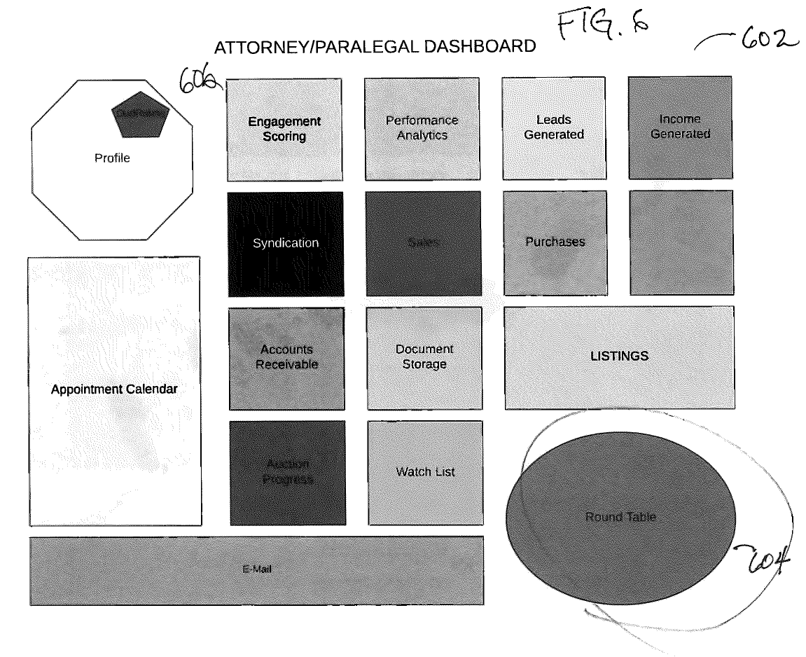

FIG. 6 illustrates an exemplary attorney or other legal professional user 102 dashboard schematic 602. The dashboard 602 can provide the legal professional user 102 with information and access to the roundtables of which they are attendees 604. Many other access options and information can also be provided including the users engagement score 606.

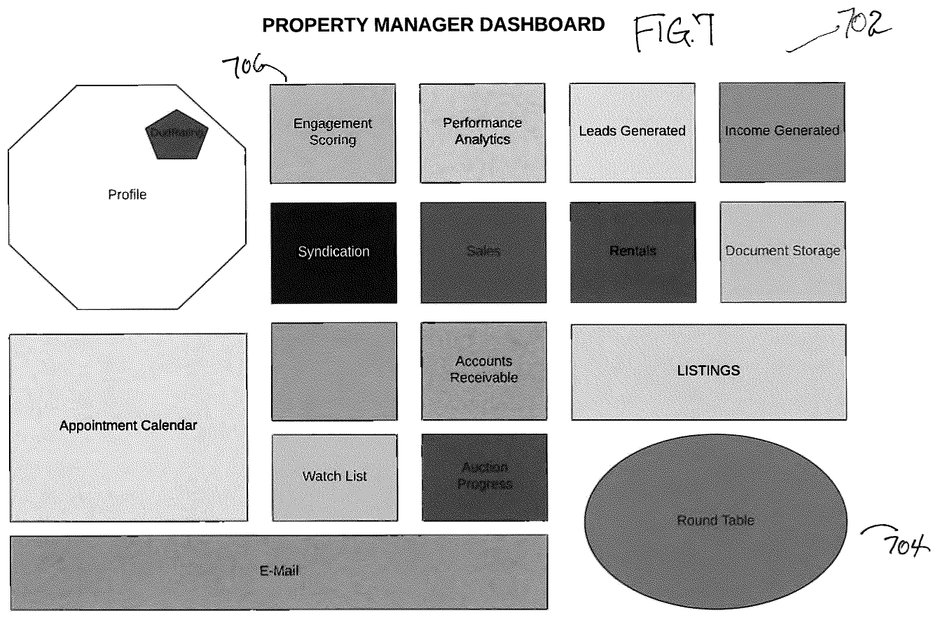

FIG. 7 illustrates an exemplary property manager user 102 dashboard 702. The dashboard schematic 702 can provide the property manager user 102 with information and access to the roundtables of which they are attendees 704. Many other access options and information can also be provided including the users engagement score 706.

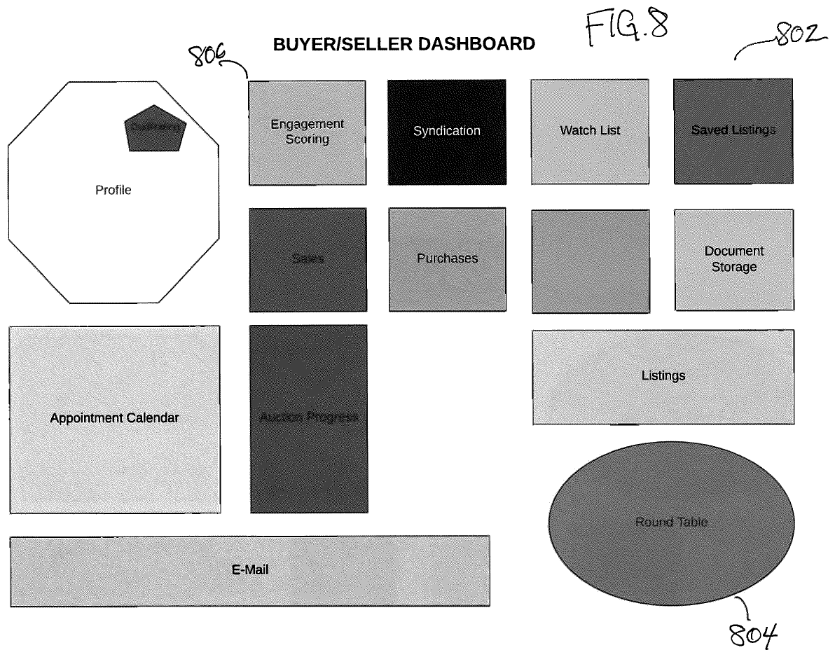

FIG. 8 illustrates an exemplary buyer or seller user 102 dashboard 802. The dashboard schematic 802 can provide the buyer/seller user 102 with information and access to the roundtables of which they are attendees 804. Many other access options and information can also be provided including the users engagement score 806.

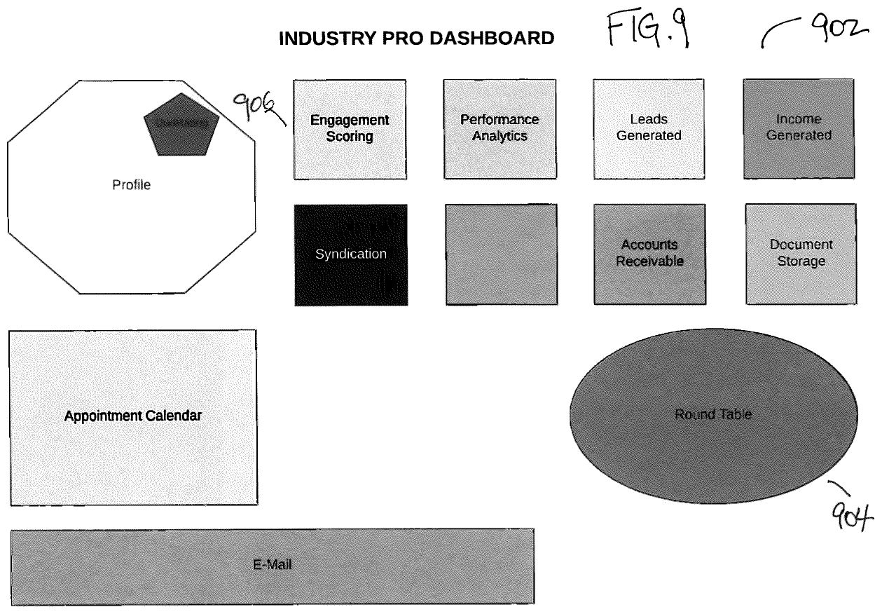

FIG. 9 illustrates an exemplary industry professional or expert user 102 dashboard schematic 902. The dashboard 902 can provide the professional/expert user 102 with information and access to the roundtables of which they are attendees 904. Many other access options and information can also be provided including the users engagement score 906.

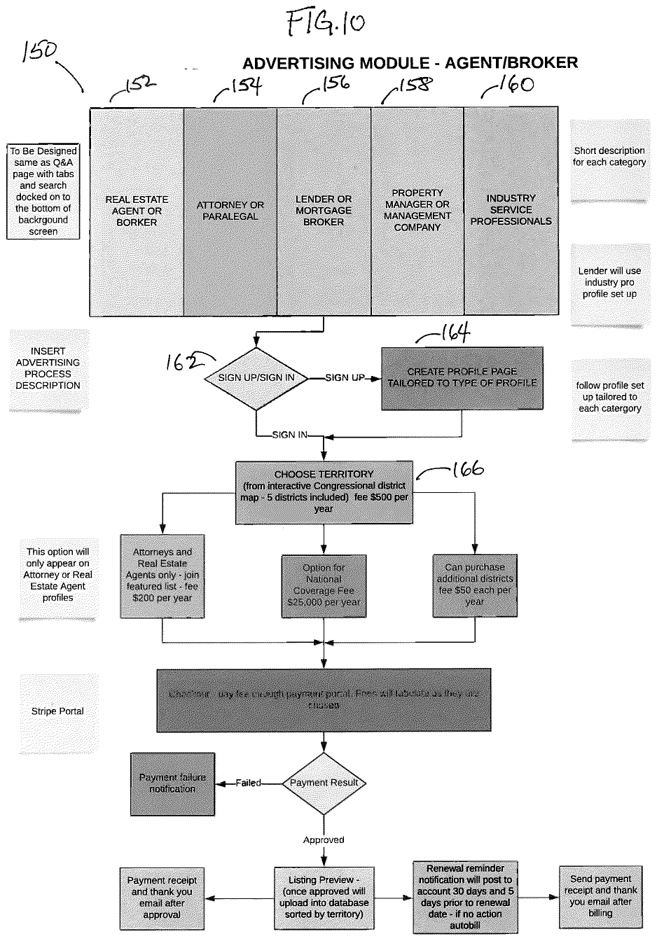

The real estate transaction system 112 can provide advertising opportunities for different users. As shown in FIGS. 10-14, different users 102 can be provided access to an advertising module 150 including real estate brokers or agents 152, legal professionals 154, lenders or mortgage brokers 156, property managers 158, or industry service professionals 160. FIG. 10 illustrates an exemplary advertising module 150 that can be provided by the real estate transaction system 112 for real estate agent/broker users 102. These real estate agent/broker users 102 can sign up for these options 162 and create a profile 164. Marketing activity can be limited to geographic areas 166 by the real estate transaction system 112. All options, payments, and approvals are executed within the module on the real estate transaction system 112.

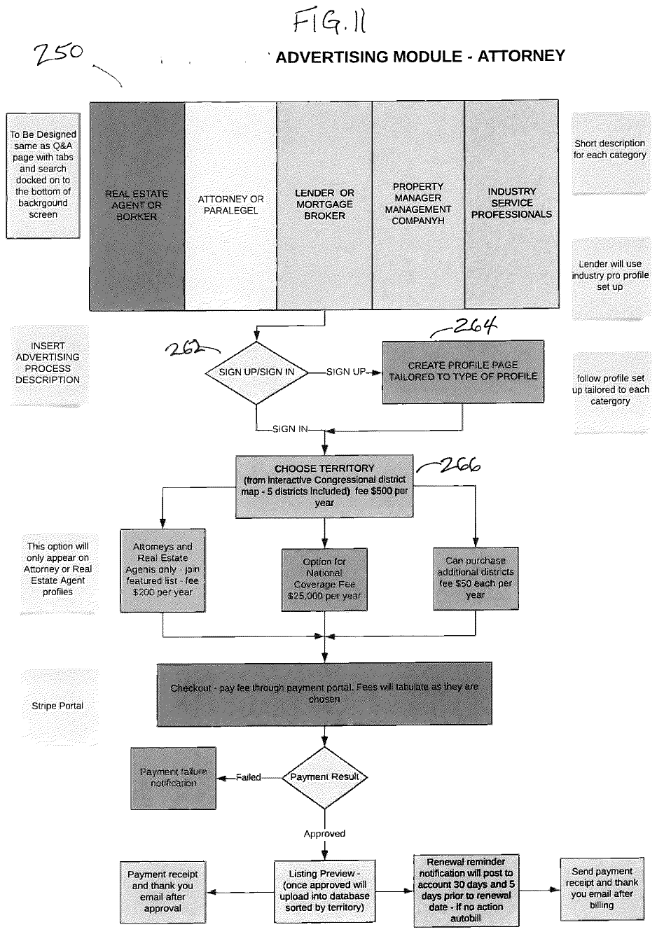

FIG. 11 illustrates an exemplary advertising module 250 that can be provided by the real estate transaction system 112 for legal professional users 102. These legal professional users 102 can sign up for these options 262 and create a profile 264. Marketing activity can be limited to geographic areas 266 by the real estate transaction system 112. All options, payments, and approvals are executed within the module on the real estate transaction system 112.

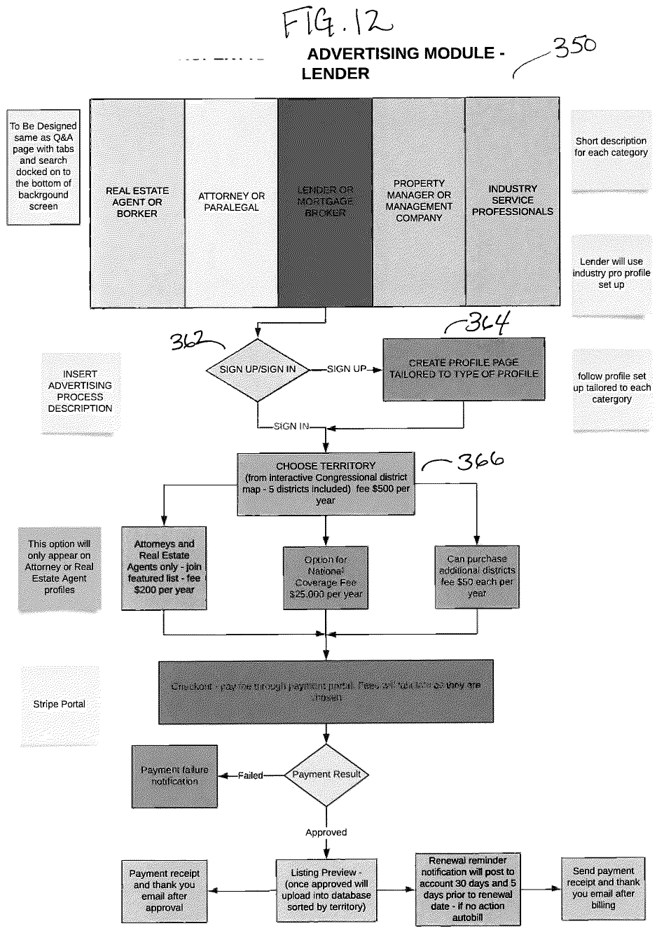

FIG. 12 illustrates an exemplary advertising module 350 that can be provided by the real estate transaction system 112 for lender/mortgage broker users 102. These lender/mortgage broker users 102 can sign up for these options 362 and create a profile 364. Marketing activity can be limited to geographic areas 366 by the real estate transaction system 112. All options, payments, and approvals are executed within the module on the real estate transaction system 112.

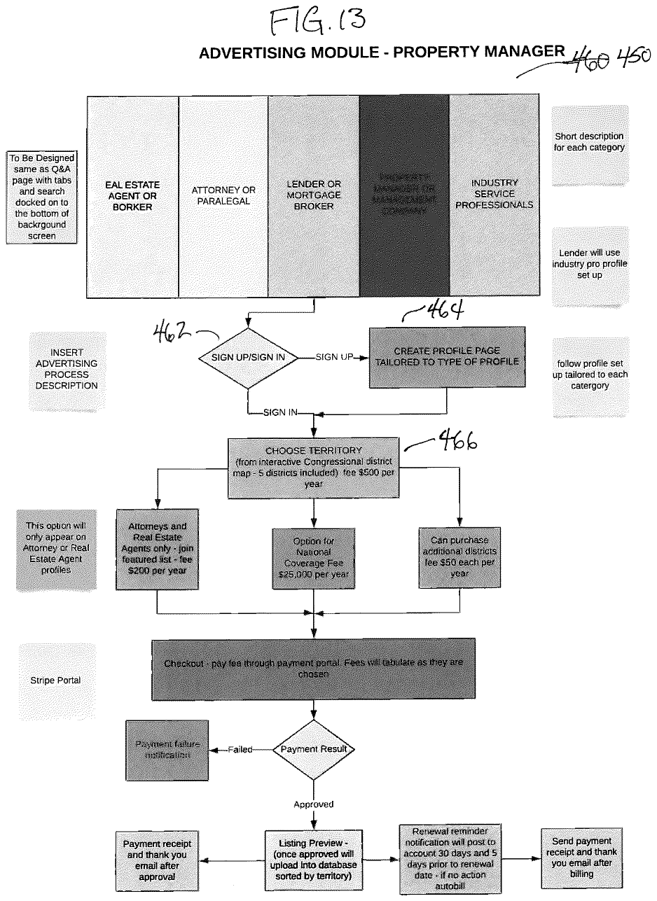

FIG. 13 illustrates an exemplary advertising module 450 that can be provided by the real estate transaction system 112 for property manager users 102. These property manager users 102 can sign up for these options 462 and create a profile 464. Marketing activity can be limited to geographic areas 466 by the real estate transaction system 112. All options, payments, and approvals are executed within the module on the real estate transaction system 112.

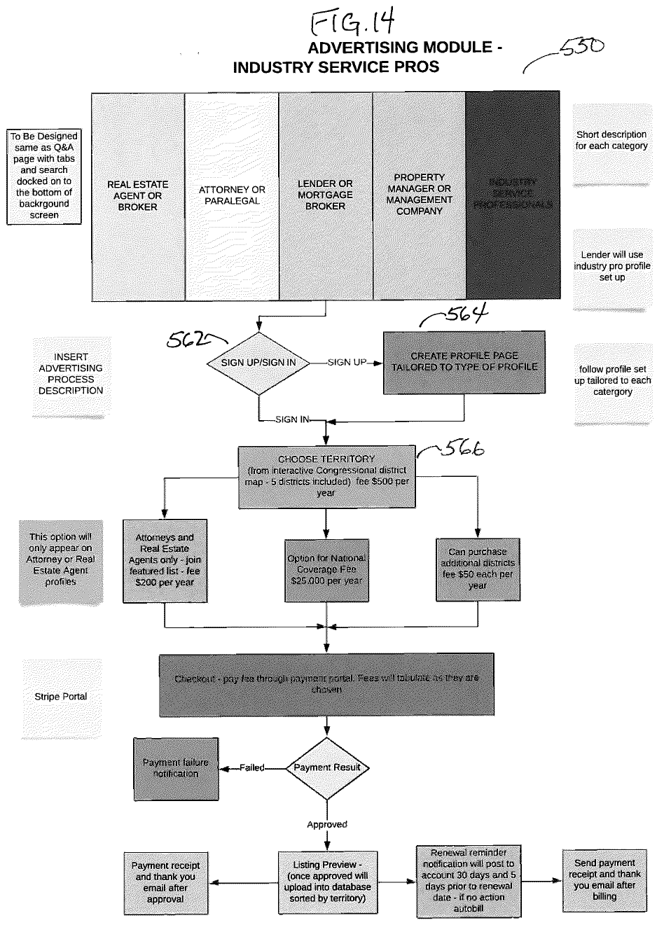

FIG. 14 illustrates an exemplary advertising module 550 that can be provided by the real estate transaction system 112 for industry service professional users 102. These industry professional users 102 can sign up for these options 562 and create a profile 564. Marketing activity can be limited to geographic areas 566 by the real estate transaction system 112. All options, payments, and approvals are executed within the module on the real estate transaction system 112.

The real estate transaction system 112 can provide search tools for a user to find other users. As shown in FIGS. 15-19, users 102 can be provided a search capability 650 for finding legal professionals 652, real estate brokers or agents 654, lenders or mortgage brokers 656, property managers 658, or industry service professionals 660. FIG. 15 illustrates an exemplary search capability schematic 650 that a user 102 can use to find a legal professional 652 for a real estate transaction that can be provided by the real estate transaction system 112. The user 102 can refine a search by legal professional name or business name 662. The user 102 can refine a search by legal professional location 664. The user 102 can refine a search by legal professional specialty 666. The search results can be filtered by distance from the user 668, rating 670, or price range 672. The search results can be sorted alphabetically 674, distance 676, rating 678, or price 680.

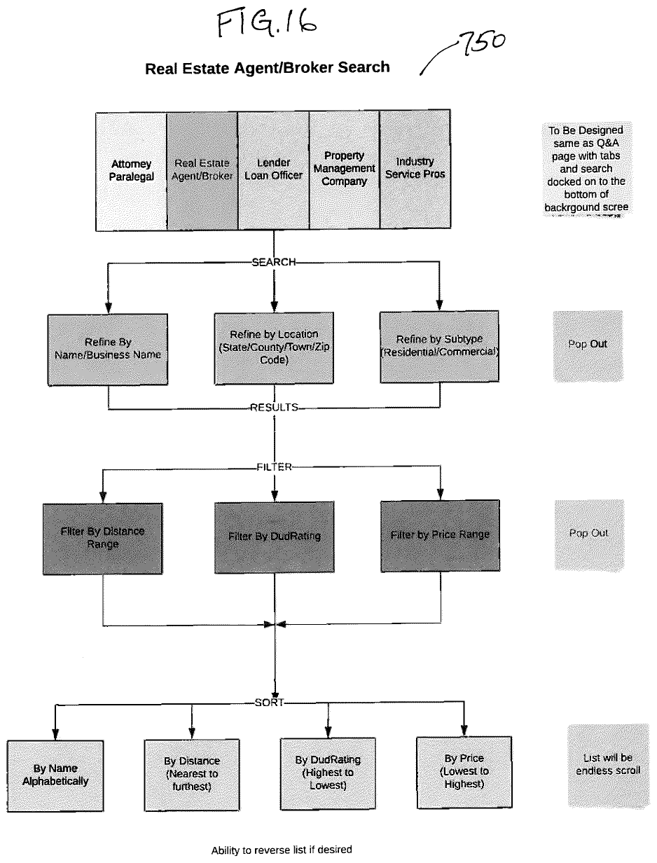

FIG. 16 illustrates an exemplary search capability schematic 750 that a user 102 can use to find a real estate agent or broker 654 for a real estate transaction that can be provided by the real estate transaction system 112.

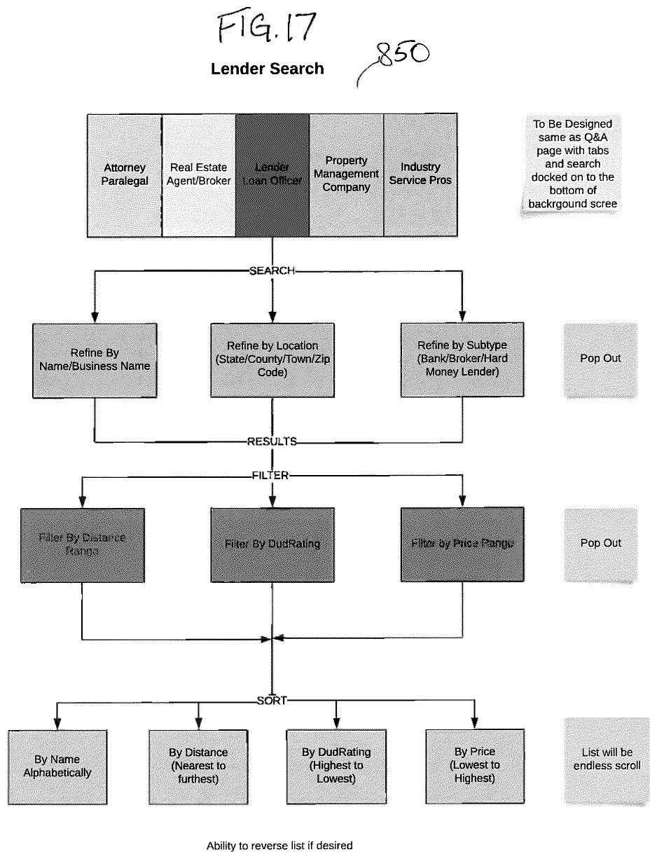

FIG. 17 illustrates an exemplary search capability schematic 850 that a user 102 can use to find a lender 656 for a real estate transaction that can be provided by the real estate transaction system 112.

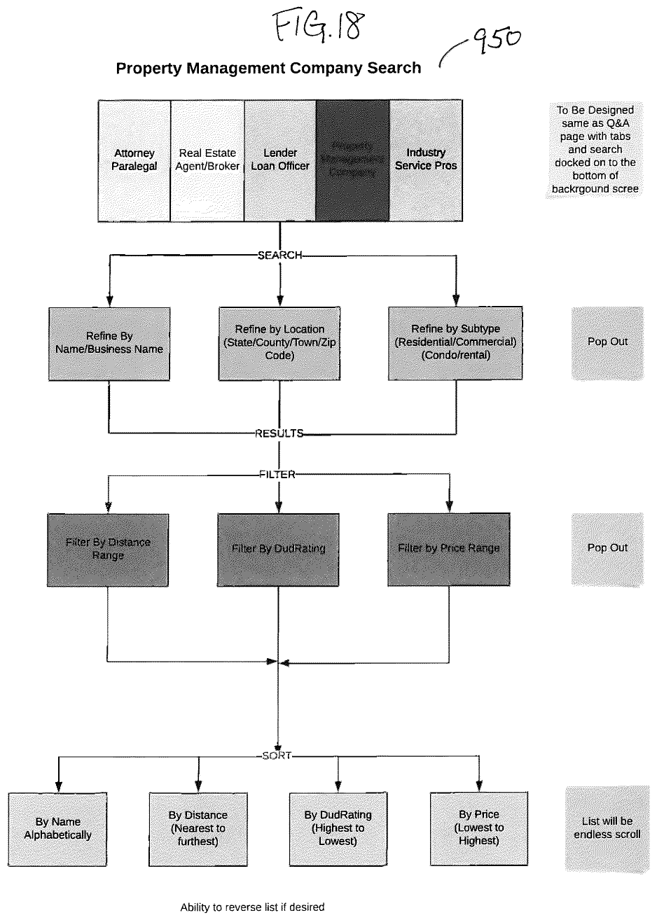

FIG. 18 illustrates an exemplary search capability schematic 950 that a user 102 can use to find a property manager 658 for a real estate transaction that can be provided by the real estate transaction system 112.

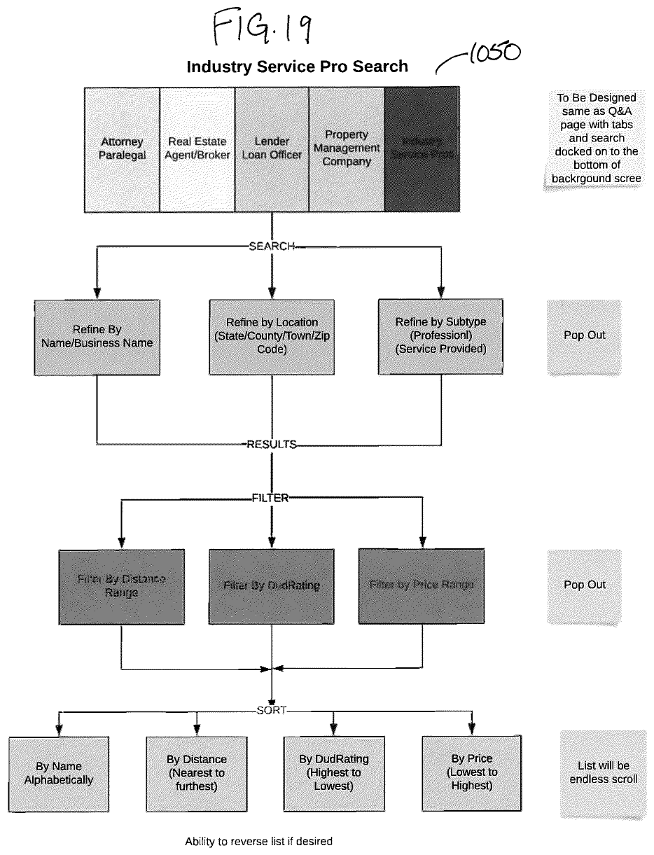

FIG. 19 illustrates an exemplary search capability schematic 1050 that a user 102 can use to find an industry professional 658 for a real estate transaction that can be provided by the real estate transaction system 112.

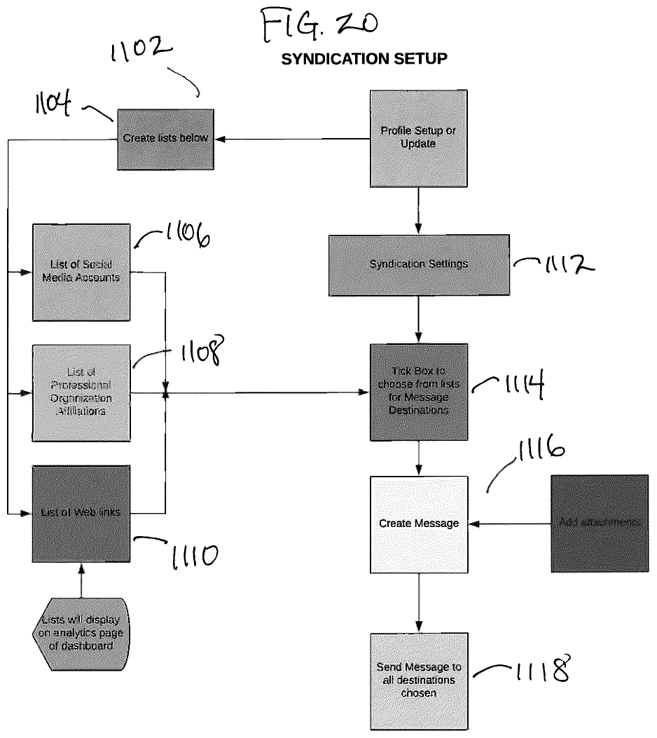

The real estate transaction system 112 can provide for syndication of a real estate transaction. FIG. 20 illustrates an exemplary syndication capability schematic 1102 that a user 102 can use to create a syndicate of users for a real estate transaction that can be provided by the real estate transaction system 112. The real estate transaction system 112 provides for a user 102 to create lists 1104 including social media accounts 1106, professional organization affiliations 1108, and website links 1110. These lists can be shown on a user's 102 dashboard. A user can also be provided by the real estate transaction system 112 syndication settings 1112, the ability to pick lists for messaging 1114, the ability to create messages 1116, and send those messages to the chosen destinations 1118.

Each user 102 of the real estate transaction system 112 can rate other users of which they have transacted real estate on the system. Once a user has interacted with another user of the real estate transaction system 112, the system provides rating capabilities based on characteristics that are properties, attributes, or values that can be associated with a user 102. Characteristics can be intrinsic, e.g., the distance from a predetermined point; user 102 fixed, e.g. law firm name; or computed, e.g., best deal based on costs and distance.

Characteristics are features that are used to compare users. They allow users to indicate preferences. The characteristics are predetermined by the system 112, and the system 112 enables users'selection of characteristics or computed characteristics, e.g. best value.

Characteristics have an inherent preference order. The values of any characteristic may be used to arrange characteristics in a best first order. For example, proximity has a predetermined preference that closer is better. Location has no predetermined preference value and a user 102 is enabled to set that themselves. This allows the system to make default assumptions and guide the selection of computed characteristics, e.g. best value. A user can filter a search for characteristics by selection criteria, e.g. filter by distance 668 (in FIG. 15).

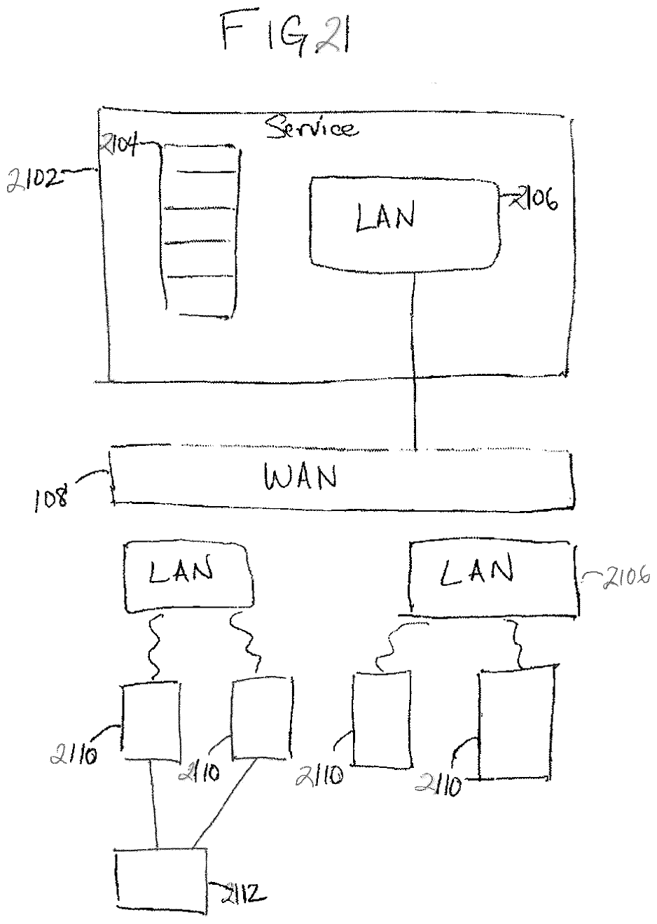

FIG. 21 is an interaction diagram of an embodiment illustrating a service 2102 provided by a set of servers 2014 to a set of client devices 2110 via various types of networks. The servers 2104 or client devices 2110 can be capable of transmitting, receiving, processing, or storing many types of signals, such as in memory as physical memory states.

The servers 2104 of the service 2102 can be internally connected via a local area network 2106 (LAN), e.g. a wired network where network adapters on the respective servers 2104 can be interconnected via cables (e.g., coaxial or fiber optic cabling), and can be connected in various topologies (e.g., buses, token rings, meshes, or trees), or a wireless network, e.g. satellite, Wi-Fi, Bluetooth. The servers 2104 can be interconnected directly, or through one or more other networking devices, such as routers, switches, or repeaters. The servers 2104 can utilize a variety of physical networking protocols (e.g., Ethernet or Fiber Channel) or logical networking protocols (e.g., variants of an Internet Protocol (IP), a Transmission Control Protocol (TCP), or a User Datagram Protocol (UDP). The local area network 2106 can include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 2106 can be organized according to one or more network architectures, such as server/client, peer-to-peer, or mesh architectures, or a variety of roles, such as administrative servers, authentication servers, security monitor servers, data stores for objects such as files and databases, business logic servers, time synchronization servers, or front-end servers providing a user/visitor-facing interface for the service 2102.

The local area network 2106 can comprise one or more sub-networks, such as can employ differing architectures, can be compliant or compatible with differing protocols or can interoperate within the local area network 2106. Additionally, a variety of local area networks 2106 can be interconnected, e.g., a router can provide a link between otherwise separate and independent local area networks 2106.

As shown in FIG. 21, the local area network 2106 of the service 2102 is connected to a wide area network 2108 (WAN) that allows the service 2102 to exchange data with other services 2202 or client devices 2110. The wide area network 2108 can encompass various combinations of devices with varying levels of distribution and exposure, such as a public wide-area network (e.g., the Internet) or a private network (e.g., a virtual private network (VPN) of a distributed enterprise).

As shown in FIG. 21, the service can be accessed by a user 2112 via the wide area network by a user of one or more client devices 2110, such as a portable media player (e.g., a portable gaming device); a portable communication device (e.g., a camera, a phone, a wearable device, an implantable device, or a text chatting device); a virtual reality output device, a workstation; or a laptop form factor computer. The respective client devices 2110 can communicate with the service 2102 via various connections to the wide area network 2108. As a first example, one or more client devices 2110 can comprise a cellular communicator and can communicate with the service 2102 by connecting to the wide area network 2108 via a wireless local area network 2106 provided by a cellular provider. As a second such example, one or more client devices 2110 can communicate with the service 2102 by connecting to the wide area network 2108 via a wireless local area network 2106 provided by a location such as the user's 2112 home or workplace (e.g., a Wi-Fi (Institute of Electrical and Electronics Engineers (IEEE) Standard 802.11) network or a Bluetooth (IEEE Standard 802.15.1) personal area network). In this manner, the servers 2104 and the client devices 2110 can communicate over various types of networks. Other types of networks that can be accessed by the servers 2104 or client devices 2110 include mass storage, such as network attached storage (NAS), a storage area network (SAN), or other forms of computer or machine-readable media.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “real estate transaction system” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous. Claims:

1. A method for operating a computer system, comprising:
at an electronic device comprising a processor and memory for storing instructions for execution by the processor:
receiving user input comprising a user profile indicative of a user request;
obtaining context information associated with the user profile of the electronic device;
processing the user profile to obtain a representation of user intent, wherein the representation of user intent associates the user profile with a task flow operationalizing a requested task, and wherein the task flow is operable to invoke one or more services of a plurality of services, each service of the plurality of services supporting one or more functions according to a respective set of one or more service parameters; and
enabling user input to execute the task flow and invoke the one or more services.

2. The method of claim 1, wherein:
the one or more services can be listing real estate property, finding another user, notifying another user, creating a roundtable, creating advertising on the computer system, or creating a syndicate.

3. The method of claim 2, wherein:
the real estate property can be land, or a manufactured home, a timeshare, residential property, commercial property, industrial property, or agricultural property.

4. The method of claim 1, wherein:
a user can be a real estate agent or broker, a legal professional, a lender or broker, a property manager, an industry professional, a buyer, or a seller.

5. A computing system comprising a server, the server configured to receive user input comprising a user request; wherein, based on the user request, the server provides a user with a predetermined user profile template.

6. The computing system as in claim 5, wherein the user request is processed to obtain a representation of the user's intent.

7. The computing system as in claim 5, further comprising:
a computing device comprising a display screen;
the computing device is in communication with the server;
the computing device is capable of receiving a prompt from the server and allowing the user to answer the prompt with the user request and communicate the user request to the server.

8. The computing system as in claim 5, wherein the predetermined user profile template is one of either a template for a real estate agent, legal professional, lender, property manager, real estate industry service professional, property buyer, property seller, or property renter.

9. A computing system comprising a processor that, based on stored instructions:
determines a user's intent upon the user accessing different modules stored on a transaction system,
provides the user with a specific task flow associated with the user's intent, wherein the task flow provides one or more services of a plurality of services, each service of the plurality of services supporting one or more functions according to a respective set of one or more service parameters.

10. The computing system as in claim 9, wherein the transaction system generates a roundtable of multiple participants based on the users'intent.

11. The computing system as in claim 10, wherein users are invited to become participants in the roundtable.

12. The computing system as in claim 9, wherein the transaction system populates a list of documents and tasks based on the user's intent.

13. The computing system as in claim 12, wherein a progress bar can be used for a task.

14. A computing device, comprising:
one or more processors;
one or memories; and
one or more programs, wherein the one or more programs are stored in the memory and configured to be executed by the one or more processors, the one or more programs including instructions for:
receiving, within a communication session between a user and a system program, a user request for the system program to receive user input comprising a user profile;
obtaining context information associated with the user profile comprising a role, expertise, abilities, user's input, user's past use, or other users'feedback;
in response to receiving the user request for the system program to receive user input comprising the user profile, determining one or more user values based on each of the context information;
using the user values based on the context information to create a roundtable of other users with compatible user values by:
identifying one or more process needed done by at least one first user;
determining other users that have compatible user values related to the first user, including the ability to contribute to the process needing to be done;
matching one or more best valued other users with the first user by choosing a closest value for each of the users;
transmitting the other users to the first user;
receiving a response from the first user indicating whether the matching was successful.
